(19) United States
(12) Patent Application Publication
(10) Pub. No.: US 2002/0044687 A1
(43) Pub. Date: Apr. 18, 2002

(54) Customer feedback system

(75) Inventor: Ami Federman, Herzlia (IL)

Correspondence Address: G. E. EHRLICH (1995) LTD., c/o ANTHONY CASTORINA, SUITE 207, 2001 JEFFERSON DAVIS HIGHWAY, ARLINGTON, VA, 22202, US

(73) Assignee: eMailcard Feedback Systems, Inc.

(21) Appl. No.: 09/776,873

(22) Filed: Feb. 6, 2001

Related U.S. Application Data
(63) Continuation of application No. 09/688,119, filed on Oct. 16, 2000.

(51) Int. Cl. G06K 9/00; G06F 15/00; G06F 17/00; G06F 17/21; G06F 17/24

(52) U.S. Cl. 382/187; 707/507

(57) ABSTRACT

A customer feedback system comprising a paper form having a plurality of regions, at least one of which is for entry of customer feedback responses, a scanner for converting data on paper into graphical format, and an electronic data reader for converting graphical format into electronic data, wherein data from said at least one region on the paper form is converted into a format suitable for electronic analysis. In order to provide an incentive to customers to provide their feedback, data from at least one other region is retained in said graphical format for sending as an electronic message to an address specified by a customer. Thus the customer is able to send an electronic postcard.

### RELATIONSHIP TO EXISTING APPLICATIONS

The present application is a continuation of U.S. Ser. No. 09/688,119 filed Oct. 16, 2000, attorney docket No. 00/21140.

### FIELD OF THE INVENTION

The present invention relates to a customer feedback system and more particularly but not exclusively to an electronic customer feedback system having a paper and pen interface to the customer and offering an incentive to the customer for using the system.

### BACKGROUND OF THE INVENTION

In many organizations it is desirable to obtain customer feedback. A common method of receiving feedback from customers of businesses is through the use of response forms such as comment cards. An owner of a business can use the responses gleaned from his customers to improve services, spot unsatisfactory areas of his products or services or to evaluate marketing techniques and potential. In short, the comments of a customer who has just patronized an establishment are one of the most powerful sources of information to the owner of the business. In the past, the inconvenience to the customer of filling out a response form or using other types of customer surveys has reduced the effectiveness and accuracy of the comments received. For example, if a response form takes more than just a few seconds for a customer to fill out, chances are that the average customer will not bother to fill out the form unless he is especially dissatisfied or satisfied with some area of the business. This inconvenience results in inaccurate data compiled from the system. Furthermore, the data should preferably should be in a form which is easy to exchange between different physical locations of the organization, and easy to process. Electronic data is easy to transmit and process.

U.S. Pat. No. 3,689,930 describes a prior art electronic device that obtains data such as customer feedback data in electronic form. The device is interactive and computerized and allows customers to anonymously input their feedback at point-of-service. The device is battery operated and can be easily mounted on a lobby stand, or placed directly on a service desk. Being portable, it can also be easily rotated between different locations. While waiting, customers interact with the device to self-administer their own surveys, anonymously. Their answers go directly into a computer inside the machine. Data is instantly retrievable in a number of different data retrieval formats: summary report, unlimited cross tabulation (including date tabulation, time tabulation), and raw data. Hard copies may be obtained on site with a hand-held (infrared) printer. It is also fully compatible for dumping of data to a PC or the like for in-depth analysis and preservation. Using associated analysis software, powerful graphs and charts may be prepared. A simple and unique questionnaire display system allows display of a printed questionnaire in an easy to read format. An extensive language library in its software permits programming in a plurality of languages. Reprogramming for a new questionnaire takes only a few minutes. All computer functions can be done externally from the alpha/numeric keyboard, including programming new questionnaires.

An alpha-numeric keyboard permits respondents to enter miscellaneous information such as general comments, their own telephone number, zip code, etc. at the end of the survey, to enable follow-up calls, and to help qualify collected data

Many people, however, are unused, unable or reluctant to provide data using an electronic interface. It is therefore common to encourage people to fill in paper forms and to manually read in data from the forms or to read the forms electronically using a scanner. Furthermore, unless a customer has strong opinions about a service or product received he does not have any particular incentive to provide customer satisfaction data.

U.S. Pat. No. 6,026,387 discloses a consumer comment reporting apparatus and method which collects, analyzes and reports information on goods and services offered for sale to consumers by providers, comprising a recording station selectively operable by consumers for recording oral comments regarding goods and services offered by the providers. The oral comments and associated time signals are communicated to an analyzer for creating discrete normalized representations including comment category, at least one descriptor, at least one dimension, and an attitude, representative of each oral comment. Normalized comments are then selected according to the comment category, descriptor, dimension, attitude, and time signal, and analyzed for reporting to the provider for use in responding to perceptions of consumers as to the services and goods offered by the store to consumers. A method of collecting, analyzing, and reporting consumer feedback comments on goods and services offered for sale to consumers by retailers is disclosed. Whilst being user-friendly in that the interface is voice, the customer does not even have to trouble about finding a pen, the data received is difficult to process and the customer is given no incentive to participate.

A typical organization that runs a customer feedback system is a hotel, and indeed paper customer satisfaction questionnaires are used by most hotels throughout the world, as well as in other businesses such as restaurants, rental cars etc. Hotels try to lure their guests to fill out these questionnaires by all kind of means like prizes, points raffles etc. However, compliance by customers is relatively low.

In general the paper-based feedback system is not computerized. Since the take-up rate is low, as mentioned above, the results obtained from customers are not statistically significant. Furthermore, if the hotel is part of a chain, then it is difficult to send the results to a central head office or to make the results available to other parts of the chain. Especially as the rate at which the forms are filled in is low, it is often difficult to justify allocating members of staff to enter data from the forms. The paper questionnaires which are filled are either analyzed manually by local management, or, in the case of a chain, the results are sent directly to the corporate headquarters. Alternatively, the forms may be sent at the end of each month to for analysis by an external company. The external company may read the forms manually or it may build an electronic database for analysis, and typically the electronic database is built using some form of optical reading system for inputting data from the forms. The external company typically produces reports which are sent back to the hotel or corporate head office.

The disadvantages with the above described possibilities are:

Customer compliance remains small and the results are thus statistically insignificant, in some cases totally invalid.

The low compliance rate often means that the customers who have filled out the questionnaires belong to the extremes, either the very satisfied or the very unsatisfied. The customers who did not fill in the forms are often the silent majority who have views that are important but not extreme.

Particularly in the case of large chains, analysis reports refer to data that is already several weeks old.

In the existing schemes, input is not tamperproof and can be manipulated both by management and staff.

The system therefore fails to provide a quality control tool that comprises effective reaction to problems as they appear including an immediate personalized reaction.

A system is therefore required in which a customer is both given an incentive to fill in a customer satisfaction form, is given a form which he feels technically comfortable with and which form can easily provide data which can be processed electronically and which is difficult to tamper with.

Postcards are widely used by travelers throughout the world and billions are sent each year. However, since buying a card, stamps and posting the card are not always convenient or easy and since trips are getting shorter, postcards may arrive after their senders return from their trip, and this reduces their popularity.

Although the number of people who use electronic devices for correspondence is growing rapidly, the great majority still find it easier and more intimate to send a handwritten postcard. This is especially true if the means for writing and sending the card is readily available and early delivery can be expected.

### SUMMARY OF THE INVENTION

According to a first aspect of the present invention there is provided a system for obtaining multiple format electronic data comprising:

a first data recognition device for extracting text via character recognition,

a second data recognition device for extracting user responses from user feedback structured form data, and

a third data recognition device for extracting graphical information and converting said data into graphical electronic format.

The system preferably further comprises a database and said user responses are structured for extraction to said database for electronic data analysis.

Preferably, said first data recognition device is operable to identify a region within said handwritten user input comprising an e-mail address, and to extract said e-mail address using character recognition.

The system preferably is operable to associate said extracted e-mail address with a region identified by said third data input recognition device and to send the contents thereof stored in graphical format comprised within an electronic mail to said e-mail address.

The system preferably further comprises a scanner for recognizing handwritten user input.

The system preferably further comprises an automatic structured form reader.

The system preferably further comprises a camera for gathering image information.

Preferably, said camera is a video camera and said image information is motion video.

According to a second aspect of the present invention, a customer feedback system comprises a data collector having a plurality of regions, at least one of which is for manual entry of customer feedback responses, a data converter for converting data on said collector into graphical format, and an electronic data reader for converting graphical format into electronic data, wherein data from said at least one region on said paper data collector is converted into a form suitable for electronic analysis, and wherein data from at least one other region is retained in said graphical format for sending as an electronic message to an address specified by a customer.

Preferably, said data collector is a customer feedback form and wherein said at least one region is a region structured as fields, each field containing a question and being designed for answering in a readily machine recognizable format.

Preferably, said data converter is a scanner.

Preferably, said electronic data reader comprises a character recognition device and a structured form reader.

The system preferably further comprises a data arrangement unit operable to arrange said data as an electronic mail in the format of a traditional postcard.

The system preferably further comprises a data addition unit for additional graphical material not originating from said data collector to be added to said electronic mail prior to sending.

Preferably, said data addition unit comprises a video camera operable to obtain multimedia data.

Preferably, said data collector has at least one further non-structured region for a customer to insert an e-mail address for sending said electronic message, which region is arranged to be identified and read by a character recognition device.

According to a third aspect of the present invention there is provided a method of sending an electronic mail message using a pen and paper interface comprising the steps of:

writing the message on paper,

writing an electronic address on a separately identifiable region on said paper,

scanning the message using an optical scanner,

arranging the scanned message into one of a plurality of graphical formats used universally for computer storage of graphical data,

identifying said separately identifiable region,

using an electronic character reader to identify said electronic address in said separately identifiable region, and

sending said message in said graphical format to said electronic address.

Preferably, said plurality of graphical formats include any one of a group comprising bitmap, JPEG, MPEG and gif formats.

According to a fourth aspect of the present invetion there is provided a method of compiling an electronic postcard using a manual interface, the method comprising:

providing a form suitable for writing on, the form having a structured region and a non-structured region,

allowing a user to write on said form,

scanning said form to reproduce said form in graphical format,

using an electronic form reader to read said structured region to extract data,

arranging said extracted data into a database suitable for data analysis, and

reproducing said non-structured region to form said electronic postcard.

The method preferably comprises the further step of associating said electronic postcard with an electronic address for sending of said electronic postcard to said address.

The method preferably comprises the further steps of obtaining image information and adding said image information to said electronic postcard.

Preferably, said image information is motion video information.

According to a fifth aspect of the present invention there is provided a server for processing data entered manually using pen-and paper style input into structured and non-structured regions on a form, said server being associated with:

a reader for reading structured form data, said reader being operable to extract answers from structured form data thus entered for insertion into a database for later analysis, and

an electronic character reader application for extracting data by reading characters from non-structured data thus input,

and wherein said server is further operable to retain other non-structured data for later use in said graphical format.

Preferably, said structured region is a survey form.

Preferably, data extracted by said electronic character reader comprises one or more electronic addresses.

The system preferably is operable to associate said data retained in said graphical format with said electronic address, thereby to form an electronic postcard for sending to said electronic address.

The system preferably is operable to associated image data with said electronic postcard.

Preferably, the server is further associated with a camera operable to obtain image data for associating with said electronic postcard.

Preferably, the system is further associated with a camera operable to obtain image and sound data for associating with said electronic postcard.

Preferably, said camera is a video camera.

According to a sixth aspect of the present invention there is provided a method for obtaining structured and non-structured data from users: the method comprising

reading in handwritten data from a form comprising structured and non-structured regions on a form,

identifying and extracting said structured data and storing said structured data in database format for subsequent analysis,

identifying and extracting said non-structured data and storing said non-structured data in graphical format.

The method preferably comprises a further step of associating said data stored in graphical format with an electronic address and sending said data stored in said graphical format to said associated e-mail address.

The method preferably comprises the further step of obtaining multimedia data and associating said multimedia data with said data stored in graphical format and said e-mail address.

According to a seventh aspect of the present invention there is provided an electronic postcard comprising

a graphical image of handwriting,

an electronic address, and

an image. The graphical image of handwriting is preferably an electronically held image of handwriting manually obtained from a user, either through imaging of paper or a like writing surface or from writing using a stylus or the like and electronically storing the movements of the stylus.

Preferably the image is a video image, although it could also be a still image, and sound data may be added to the electronic postcard

### BRIEF DESCRIPTION OF THE DRAWINGS

For a better understanding of the invention, and to show how the same may be carried into effect, reference will now be made, purely by way of example, to the accompanying drawings, in which:

FIG. 1 is a generalized diagram showing a user form for use in an embodiment of the present invention,

FIG. 2 is a generalized block diagram of a system operable in accordance with an embodiment of the present invention,

FIG. 3 is a simplified flow diagram showing in more detail the procedure following scanning used in association with the system of FIG. 2,

FIG. 4 is a simplified diagram of a central management computer connected via the Internet to computers of hotels in an associated chain,

FIG. 5 is a simplified block diagram of a further embodiment of a system operable in accordance with the present invention,

FIG. 6 is a simplified block diagram of a variation of the embodiment of FIG. 5, and

FIG. 7 is a simplified diagram showing a device according to an embodiment of the invention in use.

### DESCRIPTION OF THE PREFERRED EMBODIMENTS

The e-MailCard Feedback System according to a preferred embodiment of the present invention provides an interface between the “old way of doing things”, that is to say pen and paper, and the new Internet technology. Furthermore it satisfies the needs of the customers on the one hand, by providing him with the means to send a handwritten postcard electronically, and on the other hand it allows the hotel to obtain the required feedback or any other information, again in such a way that it is provided by the customer using pen and paper but made available to the hotel or other business in electronic form so that it can be sent and analyzed rapidly and easily.

Advantages that may be gained by the system following an improved response rate from customers include:

Providing customers with better correspondence facilities.

1. Providing the business with better and nearer real time information.

2. Improving quality control within multi-unit corporations.

3. Improving handling of customer dissatisfaction, and enables rapid assessment and response even from remotely located management.

5. Providing better rating and benchmarking information.

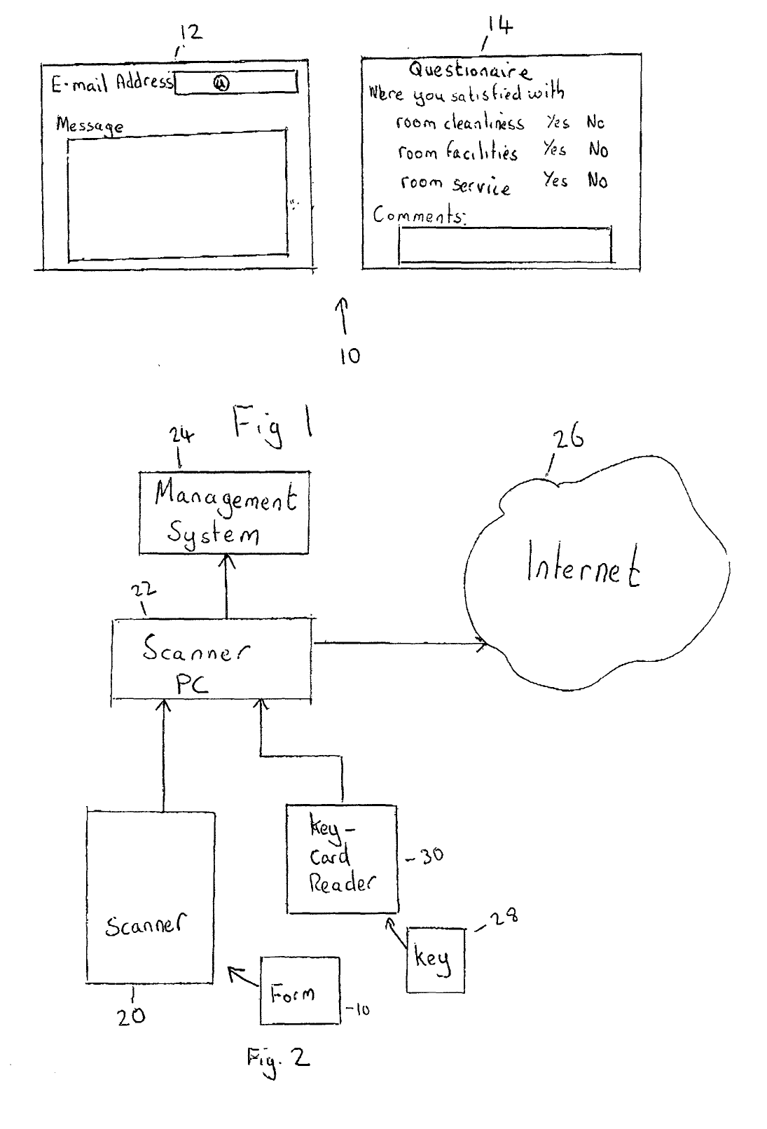

Reference is now made to FIG. 1, which is a generalized diagram showing a simplified form for use in accordance with a first embodiment of the present invention. The form 10 comprises a first side 12 and a second side 14. On the first side 12 a customer is given space to write a postcard and to enter an e-mail address. On the second side 14 a customer feedback survey appears. The survey form preferably comprises question fields in which the customer is asked various pertinent questions. Against each question the customer is given the opportunity to enter an answer. Preferably, for ease of reading by character reading equipment answers are in the form of ticks or crosses against a “yes” or a “no” or ticks or crosses against numbers. In addition to such structured parts of the form there may also be provided a section asking the customer for comments or more generally for giving the customer an opportunity to give a less structured answer.

The customer is preferably offered free and near instantaneous delivery of his postcard as a graphical e-mail in return for filling in the feedback survey. Preferably the form is more elaborate than that shown in the figure and the user may be given the space to write several postcards to several different e-mail addresses. Alternatively, the user may be able to enter several e-mail addresses to which to send a single message.

Reference is now made to FIG. 2, which is a generalized block diagram showing an embodiment of a customer feedback system operable in accordance with an embodiment of the present invention. Parts that are identical to those shown above are given the same reference numerals and are not referred to again except as necessary for an understanding of the present embodiment. Form 10 is inserted into scanner 20 for scanning.

The scanner may be a standard scanner. In the case of a hotel it may conveniently be placed at or near reception, perhaps on a special stand. The user is simply required to place the form 10 on the scanner and press a button.

The scanner 20 preferably generates image data, that is data in graphical format, which is sent to an associated PC 22. At the associated PC 22 according to a particularly preferred embodiment, software is provided for supporting operation of the scanner is provided and no intelligent processing of the data is carried out. Rather, the data is sent as it is to a central management PC 24. At the central management PC 24, optical recognition software is used to identify fields on the form and read the customer's responses. Any one of a number of optical recognition systems may be used and examples include OMR (optical mark recognition) for example as incorporated in such packages as Acuform™. Recognition errors may be corrected by human staff. The recognition system is required to carry out two different types of tasks. The e-mail address has to be identified character-by-character. The structured part of the survey referred to above preferably requires the different question fields on the form to be located and for corresponding answers to be identified. The non-structured part of the survey, if provided, may use character-by-character recognition or alternatively may simply be stored as a graphic.

A known system for identifying survey data and converting it into electronic format is known from U.S. Pat. No. 5,936,225, the contents of which are hereby incorporated by reference. In this document, a system for processing a plurality of response forms containing subsets of questions from an entire set of question is disclosed. This system includes an optical scanner for creating an optical image of the response form. The optical image is stored in an image file within a storage means by a processor. The form contained in the optical image is identified by comparing vertical and horizontal histograms of the image within the image file to vertical and horizontal histograms of prototype form images in a prototype library using the processor and a form recognition engine. Data is extracted from the form based on a comparison of response zones on the image to a library of sets of response prototypes describing completed and uncompleted responses. The closest response zone match using the histogram technique to describe the response zone and the samples becomes the data, yes or no; that is reported.

It is pointed out that the structured part of the form does not need a scanner to read it. A number of structured form readers are well-known to the skilled man and may be used in place of scanning.

The central management PC 24 may be remotely located from the scanner PC 22, particularly where the business concerned is a multiple location business such as a chain of hotels. Particularly, however, if the business is a single location business, then the two PCs 22 and 24 may in fact comprise a single machine.

As a further alternative, the central management PC may be connected to the individual scanner PCs via the Internet 26, and this is the situation illustrated in FIG. 4. Furthermore, although the e-mail postcards are here shown as being sent from the scanner PC, 22, it may in some cases be preferable to send the e-mail postcards from the central management PC 24, and this again is the situation shown in FIG. 4 below.

The post-card message is preferably not processed for character recognition at all but rather is formatted as a graphic and sent, via the Internet 26, to the e-mail address that the customer has specified in the associated address field.

In a preferred embodiment particularly for use in hotels, the scanner is associated with a key card reader 28 adapted for reading data from electronic hotel keys 30. The customer is encouraged to enter his card into the reader so that data associated with the customer, such as his room number, may be associated with the survey data or used to validate his receiving a free e-mail.

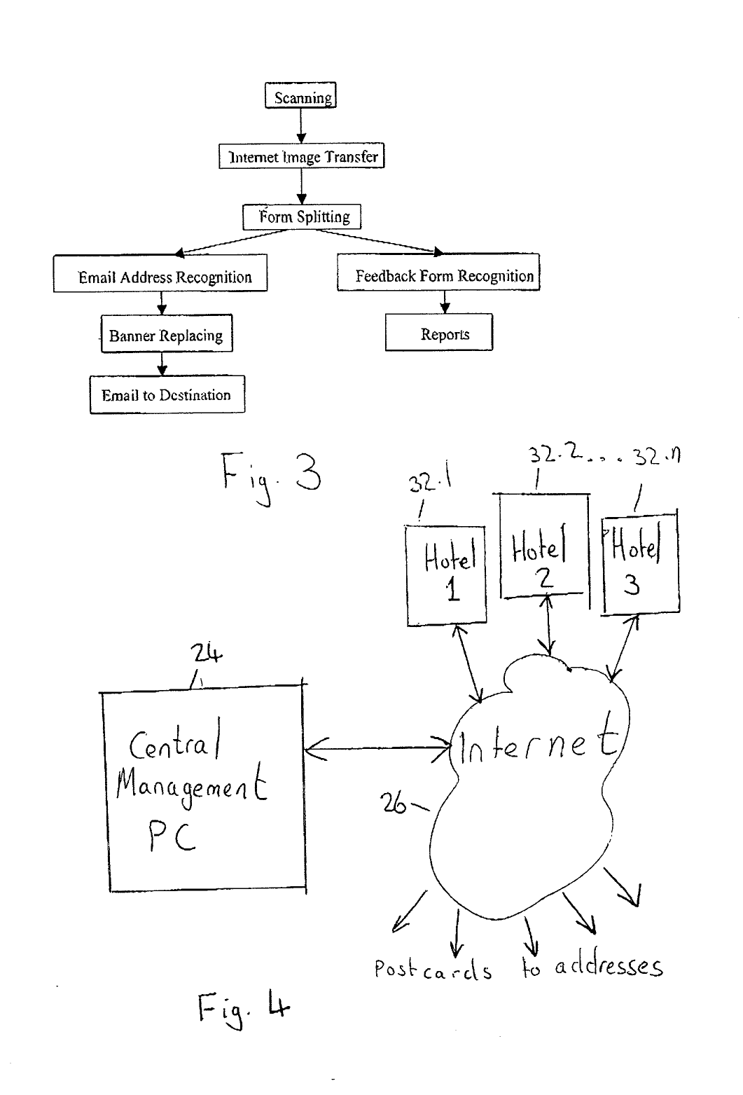

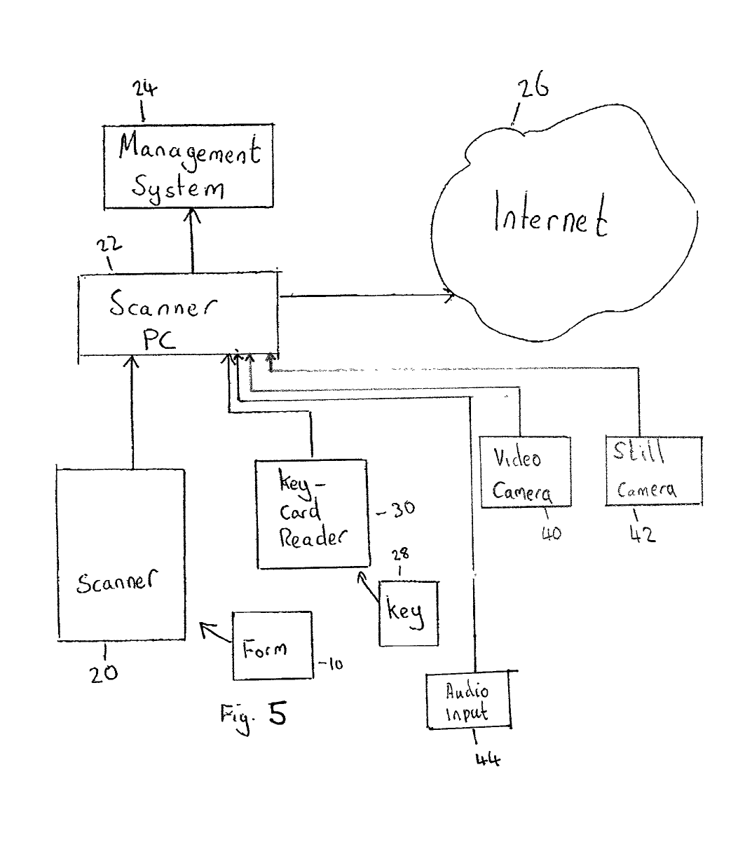

Reference is now made to FIG. 3, which is simplified flow diagram showing in greater detail the steps involved in scanning and processing the data. In a first step the card 10 is entered into the scanner and scanned. Then the data is split into two parts, the e-mail part and the survey part. The e-mail part requires optical character recognition to identify the individual characters of the address, as discussed above. The postcard itself is sent as a graphic. In addition, advertising material such as banners may be added above or below the graphic as desired. The banners may include the logo of the hotel from which the card is being sent. Other banners intended to appear on the recipient's screen may be inserted above or below the graphic according to predefined rules. Preferably the system includes simple software to determine whether the e-mail address is a valid e-mail address. In addition, should the card be sent back from the Internet in the event of the e-mail address being non-existent, then a facility is preferably provided for informing the user and permitting him to correct the address. Effective operation of the facility may depend on how quickly the notification is received from the Internet.

The other part of the form, the survey part, is preferably analyzed as described above using standard feedback form recognition systems. Resulting data is accumulated in database software as desired and reports are produced for sending to head office or to the branches of the chain for analysis. The data may be arranged and reported daily or at any other preferred intervals.

Any non-structured part of the survey response may be sent to head office as an e-mail, in the same way as the electronic postcard, except that instead of being associated with an e-mail address entered by the user on the form, it is automatically associated with an e-mail address of an appropriate recipient within the organization.

Reference is now made to FIG. 4, which is a simplified diagram of an embodiment of the present invention in which the e-mail postcards are sent from the central management PC 24. In FIG. 4, the data is received from the individual scanners at the central management PC 24 and is processed to provide reports etc. as described above. The data may be further processed by management if desired. Feedback and analysis are then sent back to the individual branches 32.1 . . . 32.n in the chain.

It is noted that the system may be used to send e-mails without wishing to use the customer feedback aspect. In this case, the customer simply writes out his postcard message in the appropriate region and fills in an e-mail address. The form is scanned as before.

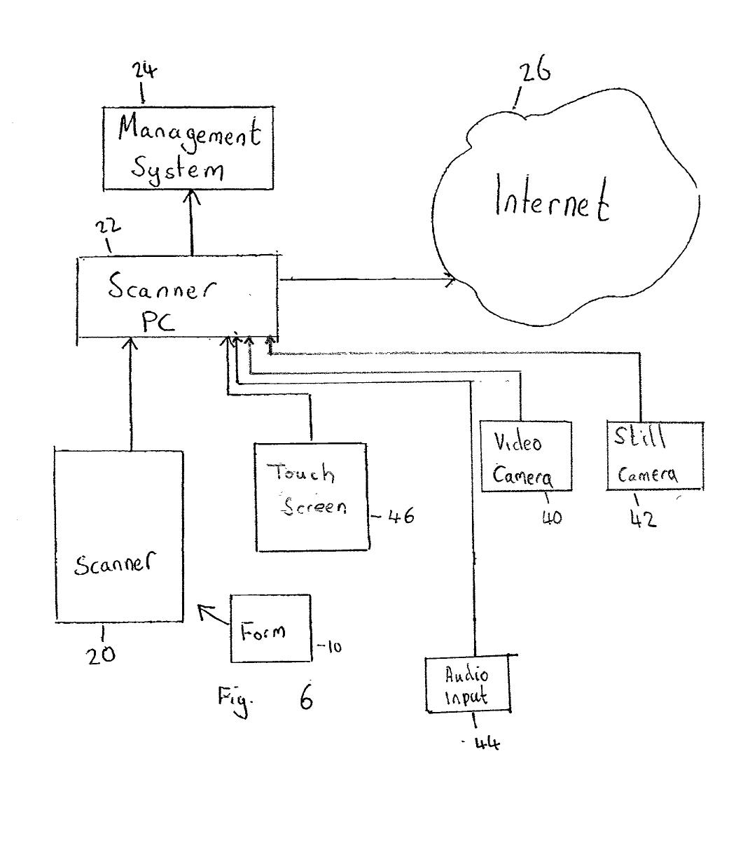

Reference is now made to FIG. 5, which is a simplified block diagram of a further embodiment of the present invention. Parts that are identical to those shown above are given the same reference numerals and are not referred to again except as necessary for an understanding of the present embodiment. In the embodiment of FIG. 5 the scanner 20 is accompanied by a video camera 40. The video camera is preferably operable to obtain multimedia data such as motion video and sound for adding to the postcard. In one embodiment the video camera 40 is operable to obtain still images as well as motion video. In another embodiment a still camera 42 is provided alternatively or additionally to the video camera. Thus the user is able to send still or motion pictures and sound as desired as part of his postcard.

An audio input 44, such as a microphone, is provided to allow the user to record an audio message for attaching to the card if desired. Preferably the audio input is able to operate together with the video camera 40 to produce a combined recording. In a preferred embodiment the audio input 44 is part of the video camera 40.

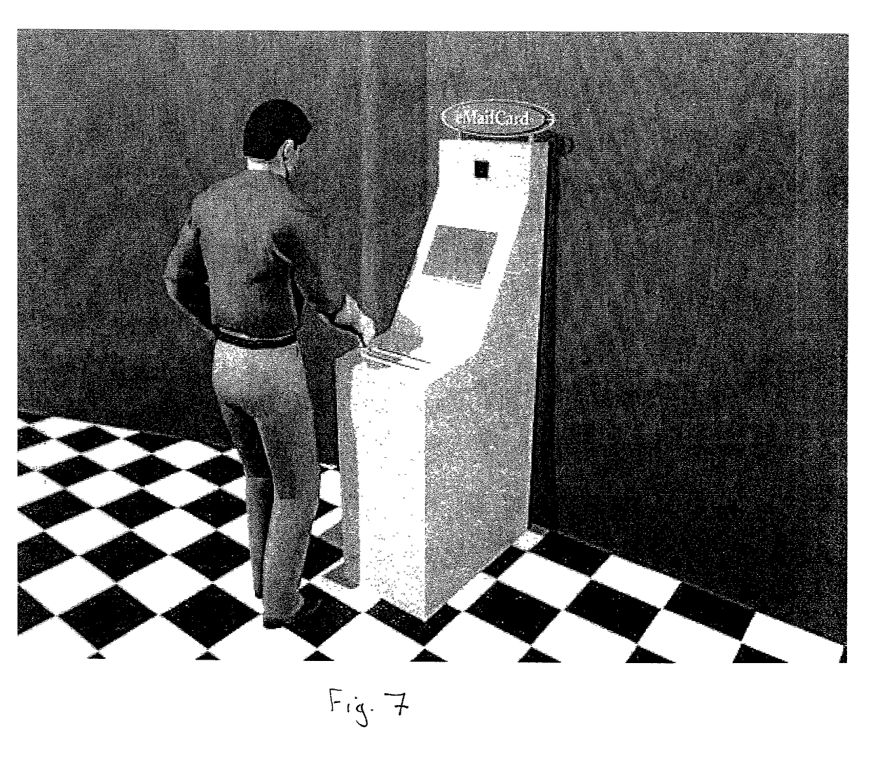

Reference is now made to FIG. 6, which is an variation of the device of FIG. 5. In the embodiment of FIG. 6, Parts that are identical to those shown above are given the same reference numerals and are not referred to again except as necessary for an understanding of the present embodiment. The key card reader 30 is replaced with a touch screen 46 which preferably shows animated instructions for the preparation of an e-mail postcard and allows the user to input data by pressing on “soft” (i.e. software defined) buttons. For example the user may use the buttons to enter his room details and perhaps also the destination e-mail address. Typically the user is given a choice of writing the e-mail address for interpreting by the character recognition feature or entering it via the touch screen 46.

Reference is now made to FIG. 7, which is an illustration of the embodiment of FIG. 6 being used for sending an electronic post-card. An input device 50 comprises a touch-screen 52, a scanning slot 54, and a video camera port 56. A user fills in a form with the text he wishes to use, and provides answers to a survey. The form is scanned in the slot 54. A destination e-mail address may be entered on the form or may be entered via the touch-screen 52. Room details are preferably entered via the touch-screen 52. Any feedback to the user, for example to say that the e-mail address cannot be interpreted, is provided via the touch-screen 52, and operation of the video camera is also preferably via the touchscreen.

There is thus preferably provided a system in which customers are able to utilize a pen and paper interface and are given an incentive to fill in a customer feedback form. At the same time the data is made available in electronic form with all of the associated advantages.

It is appreciated that features described only in respect of one or some of the embodiments are applicable to other embodiments and that for reasons of space it is not possible to detail all possible combinations. Nevertheless, the scope of the above description extends to all reasonable combinations of the above described features.

The present invention is not limited by the above-described embodiments, which are given by way of example only. Rather the invention is defined by the appended claims.

We claim:

1. A system for obtaining multiple format electronic data comprising:
a first data recognition device for extracting text via character recognition,
a second data recognition device for extracting user responses from user feedback structured form data, and
a third data recognition device for extracting graphical information and converting said data into graphical electronic format.

2. A customer feedback system according to claim 1, further comprising a database and wherein said user responses are structured for extraction to said database for electronic data analysis.

3. A customer feedback system according to claim 1, wherein said first data recognition device is operable to identify a region within said handwritten user input comprising an e-mail address, and to extract said e-mail address using character recognition.

4. A customer feedback system according to claim 3, being operable to associate said extracted e-mail address with a region identified by said third data input recognition device and to send the contents thereof stored in graphical fornat comprised within an electronic mail to said e-mail address.

5. A customer feedback system according to claim 1, comprising a scanner for recognizing handwritten user input.

6. A customer feedback system according to claim 1, comprising an automatic structured form reader.

7. A customer feedback system according to claim 1, further comprising a camera for gathering image information.

8. A customer feedback system according to claim 7, wherein said camera is a video camera and said image information is motion video.

9. A customer feedback system comprising a data collector having a plurality of regions, at least one of which is for manual entry of customer feedback responses, a data converter for converting data on said collector into graphical format, and an electronic data reader for converting graphical format into electronic data, wherein data from said at least one region on said paper data collector is converted into a form suitable for electronic analysis, and wherein data from at least one other region is retained in said graphical format for sending as an electronic message to an address specified by a customer.

10. A customer feedback system according to claim 9, wherein said data collector is a customer feedback form and wherein said at least one region is a region structured as fields, each field containing a question and being designed for answering in a readily machine recognizable format.

11. A customer feedback system according to claim 9, wherein said data converter is a scanner.

12. A customer feedback system according to claim 9, wherein said electronic data reader comprises a character recognition device and a structured form reader.

13. A customer feedback system according to claim 9, comprising a data arrangement unit operable to arrange said data as an electronic mail in the format of a traditional postcard.

14. A customer feedback system according to claim 13, comprising a data addition unit for additional graphical material not originating from said data collector to be added to said electronic mail prior to sending.

15. A customer feedback system according to claim 14, wherein said data addition unit comprises a video camera operable to obtain multimedia data.

16. A customer feedback system according to claim 11, said data collector having at least one further non-structured region for a customer to insert an e-mail address for sending said electronic message, which region is arranged to be identified and read by a character recognition device.

17. A method of sending an electronic mail message using a pen and paper interface comprising the steps of:
writing the message on paper,
writing an electronic address on a separately identifiable region on said paper,
scanning the message using an optical scanner,
arranging the scanned message into one of a plurality of graphical formats used universally for computer storage of graphical data,
identifying said separately identifiable region,
using an electronic character reader to identify said electronic address in said separately identifiable region, and
sending said message in said graphical format to said electronic address.

18. A method according to claim 17, wherein said plurality of graphical formats include any one of a group comprising bitmap, JPEG, MPEG and gif formats.

19. A method of compiling an electronic postcard using a manual interface, the method comprising:
providing a form suitable for writing on, the form having a structured region and a non-structured region,
allowing a user to write on said form,
scanning said form to reproduce said form in graphical format,
using an electronic form reader to read said structured region to extract data,
arranging said extracted data into a database suitable for data analysis, and
reproducing said non-structured region to form said electronic postcard.

20. A method according to claim 19, comprising the further step of associating said electronic postcard with an electronic address for sending of said electronic postcard to said address.

21. A method according to claim 19, comprising the further steps of obtaining image information and adding said image information to said electronic postcard.

22. A method according to claim 21, wherein said image information is motion video information.

23. A server for processing data entered manually using pen and paper style input into structured and non-structured regions on a form, said server being associated with:
a reader for reading structured form data, said reader being operable to extract answers from structured form data thus entered for insertion into a database for later analysis, and
an electronic character reader application for extracting data by reading characters from non-structured data thus input,
and wherein said server is further operable to retain other non-structured data for later use in said graphical format.

24. A server according to claim 23, wherein said structured region is a survey form.

25. A server according to claim 23, wherein data extracted by said electronic character reader comprises one or more electronic addresses.

26. A server according to claim 25, operable to associate said data retained in said graphical format with said electronic address, thereby to form an electronic postcard for sending to said electronic address.

28. A server according to claim 26, further operable to associated image data with said electronic postcard.

29. A server according to claim 26, further associated with a camera operable to obtain image data for associating with said electronic postcard.

30. A server according to claim 26, further associated with a camera operable to obtain image and sound data for associating with said electronic postcard.

31. A server according to claim 30, wherein said camera is a video camera.

32. A method for obtaining structured and non-structured data from users: the method comprising
reading in handwritten data from a form comprising structured and non-structured regions on a form,
identifying and extracting said structured data and storing said structured data in database format for subsequent analysis,
identifying and extracting said non-structured data and storing said non-structured data in graphical format.

33. A method according to claim 32, comprising a further step of associating said data stored in graphical format with an electronic address and sending said data stored in said graphical format to said associated e-mail address.

34. A method according to claim 33 comprising the further step of obtaining multimedia data and associating said multimedia data with said data stored in graphical format and said e-mail address.

35. An electronic postcard comprising
a graphical image of handwriting,
an electronic address, and
an image.

36. An electronic postcard according to claim 35, wherein the image is a video image.

37. An electronic postcard according to claim 35 further comprising sound data.
